(19) United States
(12) Patent Application Publication
(10) Pub. No.: US 2012/0181428 A1
(43) Pub. Date: Jul. 19, 2012

(54) DEVICE AND METHOD FOR CONTROLLING AN IRRADIATION SYSTEM

(76) Inventors: Christoph Bert, Aschaffenburg (DE); Eike Rietzel, Weiterstadt (DE)

(21) Appl. No.: 13/384,236

(22) PCT Filed: Jun. 18, 2010
(86) PCT No.: PCT/EP10/58598

§ 371 Date: Apr. 9, 2012

(30) Foreign Application Priority Data
Jul. 15, 2009 (DE) 10 2009 033 284.7

(51) Int. Cl. G21K 5/02

(52) U.S. Cl. 250/336.1

(57) ABSTRACT

The present embodiments relate to a device for controlling an irradiation system for irradiating a moving target volume. The device includes an evaluation device for evaluating a substitute movement signal. The device also includes an imaging device for recording image data of the moving target volume. The imaging device is activated or deactivated by a control device according to the evaluation of the substitute movement signal. The device includes an image evaluation device for evaluating the image data recorded by the imaging device, and an irradiation device that is activated or deactivated using an irradiation control device according to the evaluation of the image data.

The present patent document is a §371 nationalization of PCT Application Serial Number PCT/EP2010/058598, filed Jun. 18, 2010, designating the United States, which is hereby incorporated by reference. This patent document also claims the benefit of DE 10 2009 033 284.7, filed Jul. 15, 2009, which is also hereby incorporated by reference.

### BACKGROUND

The present embodiments relate to a device and a method for controlling an irradiation system for irradiating a moving target volume.

Particle therapy is an established method for treating tissue (e.g., in tumor diseases). However, irradiation methods of the kind employed in particle therapy are also used in non-therapeutic fields. For example, these fields include research work such as for product development in the context of particle therapy done on inanimate phantoms or bodies, irradiation of materials, and so forth.

In these, charged particles such as protons, carbon ions or other ions are accelerated to high energy levels, shaped into a particle beam, and carried via a high-energy transportation system to one or more irradiation chambers. In the irradiation chambers, the object to be irradiated, having a target volume, is irradiated with the particle beam.

In the course of the irradiation, the target volume to be irradiated may move. For example, when a patient is being irradiated, motion of the patient while breathing may cause the tumor that is to be irradiated to move. Such a movement may, for example, also be simulated for research purposes by using model objects (e.g., phantoms).

Irradiation methods known by the term “gating” are one known way of handling the movement of the target volume. Gating provides that the movement of the target volume is monitored, and the beam, with which the irradiation of the target volume is effected, is switched on and off as a function of the monitoring. In this way, the beam is activated for irradiation only when the target volume is located at the proper point.

Methods, in which an external substitute motion signal that provides information about the status of the movement of the target volume is recorded, are known. For example, the motion of the abdominal wall may be measured. From the measured motion, a conclusion may be drawn about the location of the target volume inside the body.

Methods, in which the actual motion of the target volume is monitored directly (e.g., by X-ray images, fluoroscopic images, ultrasound imaging, or active implanted transponders), are also known.

### SUMMARY AND DESCRIPTION

The present embodiments may obviate one or more of the drawbacks or limitations in the related art. For example, a device and a method for controlling an irradiation system that allow precise adaptation of the irradiation of a moving target volume while minimizing the burden on the patient and on the irradiation system is provided.

The following description of the individual features of the present embodiments relates to both the device and the method without explicit mention thereof in each case. The individual features disclosed may also be provided in other combinations than those shown. A device for controlling an irradiation system for irradiating a moving target volume includes an evaluation device for evaluating a substitute motion signal. The substitute motion signal is a signal varying as a function of the motion of the target volume. The device also includes an imaging device for recording image data of the moving target volume. The imaging device includes a control device for controlling the imaging device. The control device is configured for activating and deactivating the imaging device as a function of the evaluation of the substitute motion signal. The device includes an image evaluation device for evaluating the image data recorded by the imaging device. The device also includes an irradiation device having an irradiation control device. The irradiation control device is configured for controlling an irradiation procedure as a function of the evaluation of the image data and/or of the substitute motion signal (e.g., for activating and deactivating the irradiation device).

Using a substitute motion signal for controlling the irradiation system is problematic, even though using a substitute motion signal may be done using comparatively simple and inexpensive means.

The substitute motion signal is a signal that characterizes the motion of the target volume indirectly. In contrast, imaging methods may depict the target volume directly and thus may directly display the target volume or the position of the target volume. However, it is a precondition for using the substitute motion signal for controlling the irradiation system that there be a correlation between the position of the target volume and the substitute motion signal. This correlation, which may be determined prior to an irradiation session, may vary over time.

If a gating process, for example, is done based on the substitute motion signal, the gating process leads to the desired successful irradiation only if the previous correlation still applies. If a change in the correlation between the substitute motion signal and the motion of the target volume has occurred, the result may be that the dose is not deposited in the target volume as planned.

In the worst case, this may provide that the substitute motion signal incorrectly represents the motion of the target volume and that the target volume is not even irradiated at all. In irradiation of a lung tumor, for example, between the internal motion of the lung tumor and the externally detected substitute variable, a phase shift may occur in the periodic alternation between inhalation and exhalation. This provides that the extreme positions of the target volume no longer match the extremes of the externally detected substitute variable.

The use of an imaging device that continuously or quasi-continuously records image data of the moving target volume is advantageous because the imaging device accurately represents the location of the target volume. However, a large number of image data occur. The evaluation of image data is complicated. Continuous or quasi-continuous radioscopy of the patient with X-rays involves a high radiation exposure.

The imaging device may be an imaging device that uses X-rays and that performs radioscopy on the target volume to be irradiated. With the imaging device, image data that correlate with the status of the target volume may be obtained. It may not be necessary to generate depictions of the target volume from the image data; the image data may be used without reconstruction of a depiction in order to obtain data about the status of the target volume. The image data are then used to control the irradiation procedure.

In one embodiment, the evaluation device evaluates the substitute motion signal. With the substitute motion signal, an adequate prediction of the motion trajectory of the target volume may be made. On the basis of the substitute motion signal, the imaging device is triggered so that the imaging device no longer records image data continuously, but only at certain times in the motion cycle of the target volume. The image data are evaluated, and based on this evaluation, the irradiation device is activated or deactivated, for example. During one motion cycle, image data occur at only decided-upon times so that overall, fewer image data is evaluated for controlling the evaluation. The imaging device is active only at certain times in the motion cycle, so that for a patient, the overall radiation exposure is lower.

The image data recorded by the imaging device may thus be used in a gating process for controlling the irradiation device, by activation or deactivation of the irradiation device. Alternatively or in addition, image data may also be used (optionally jointly with the substitute motion signal) for controlling a tracking process and/or a rescanning process. In a tracking process, the beam tracks the motion of the target volume. The motion of the target may be tracked using the recorded image data, for example. In a rescanning process, an irradiation dose is applied repeatedly so that any incorrect irradiations of the target volume are reduced by averaging out the repeatedly applied irradiation doses. The individual rescanning events (e.g., starting times) may be determined using the recorded image data.

Advantageously, the device also includes a detection device for recording the substitute motion signal at a sampling rate of at least 10 Hz (e.g., at least 30 or 100 Hz, up to several kHz). The higher the sampling rate, the more precisely the substitute motion signal may be detected. The substitute motion signal (e.g., an external substitute motion signal) may be monitored by various known sensors (e.g., external sensors). Possible sensors, with which a respiratory movement may, for example, be monitored, are sensors for measuring the temperature of the breath, the breathing flow, the motion of the abdominal wall, or the motion of the thorax. From the substitute motion signal, a conclusion about the motion of the target volume, which may be located internally, may only be indirectly drawn.

Advantageously, the image evaluation device is operable to perform a comparison of the recorded image data with further image data recorded at an earlier time. The image evaluation device may be configured such that the image data are evaluated immediately after being acquired. From the comparison with image data recorded earlier, it is comparatively simple to ascertain the actual location of the target volume at the time the image data are recorded and/or whether the location of the target volume is equivalent to the expected location.

Image data from a planning data set are an example of possible further image data. For example, from a planning CT, a digitally reconstructed radiograph (DRR) that has the same orientation, in which the imaging device is also recording radioscopy image data from the target volume, may be generated. This simplifies calibration. A calibration of radioscopy image data for other plane images (slices through an associated magnetic resonance imaging data set) may also be made.

The reference image may also be generated using the same imaging device, with which the image data triggered by the substitute motion signal are recorded.

The comparison may, for example, be performed by known methods of image registration. The image registration processes may be performed on high-speed computer systems with, for example, fast GPUs, and are capable of making a comparison essentially in real time.

The comparison of the recorded image data may be used to ascertain whether the irradiation device may be activated, or not. If deviations from the planned-for internal anatomy are found, then the irradiation device will not be turned on.

Advantageously, the image evaluation device is operable to ascertain a difference between the recorded image data and the further image data. The irradiation device is configured such that the irradiation device is activated only when the ascertained difference is below a threshold value. The threshold value for acceptable deviations or optionally, a plurality of threshold values, makes flexible adaptation of the method possible, since an exact match between the recorded image data and the further image data may not be expected.

The irradiation device may be configured such that a time slot, during which the irradiation device is activatable is varied and/or adapted as a function of the evaluation of the image data.

According to the present embodiments, the method for controlling an irradiation system for irradiation of a moving target volume includes evaluating a substitute motion signal, the substitute motion signal being a signal varying as a function of a motion of the target volume. The method also includes recording image data of the moving target volume as a function of the evaluation of the substitute motion signal. The method includes evaluating the recorded image data and controlling the irradiation procedure as a function of the evaluation of the recorded image data.

In one embodiment, the substitute motion signal is recorded at a sampling rate of at least 10 Hz. This may be performed unproblematically, since the substitute motion signal may be a simple signal that permits a high sampling rate.

Evaluating the recorded image data may be done by making a comparison of the recorded image data with image data recorded at an earlier time. In the comparison of the recorded image data with the further image data, a difference may be ascertained (e.g., by subtraction).

As soon as the ascertained difference is below a threshold value, that is an indication that an assumed correlation between the substitute motion signal and the actual motion of the target volume is still valid. In that case, the irradiation device may be activated. If the difference is above the threshold value, however, activation of the irradiation device is prevented, because the risk of incorrect irradiation is too high.

The evaluation of the image data may be used for modifying time slots, during which the irradiation device is activated. In other words, the evaluation of the image data may be used for having an influence on a gating procedure that is to be done.

The method may be employed in therapeutic treatments, in which actual irradiation of a human or animal body takes place. However, the method may also be employed as a nontherapeutic method (e.g., if the irradiation is merely simulated or if objects other than a human or animal body are irradiated, as in the irradiation of a phantom or the irradiation of materials).

### BRIEF DESCRIPTION OF THE DRAWINGS

FIG. 1 is a schematic illustration of one embodiment of a particle therapy system with various components for monitoring the motion of a target volume to be irradiation; and

FIGS. 2-6 are flow charts of various embodiments of methods for controlling an irradiation system for irradiation of a moving target volume.

### DETAILED DESCRIPTION OF THE DRAWINGS

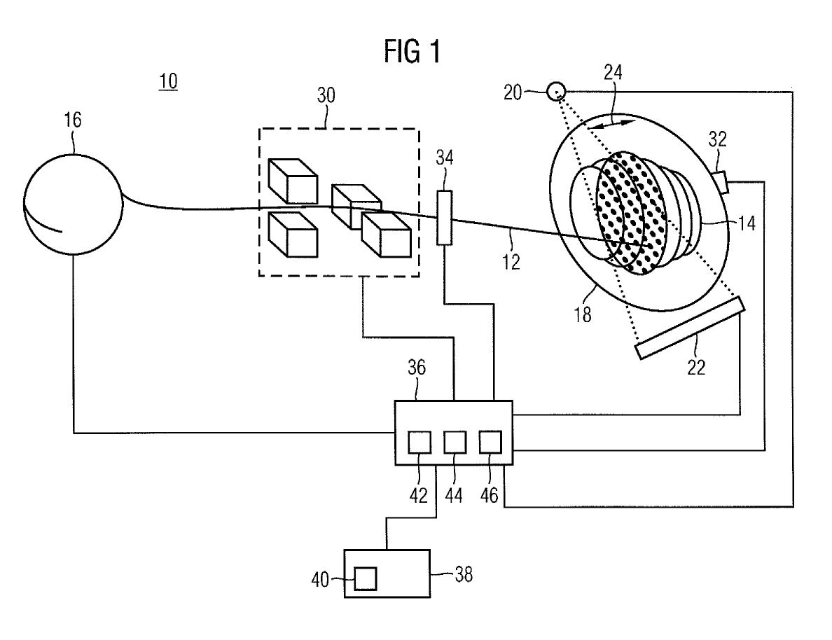

FIG. 1, in a schematic illustration, shows a layout of a particle therapy system 10. The particle therapy system 10 is used for irradiating a body located on a positioning device with a beam of particles (e.g., a particle beam 12). For example, a tumor-diseased tissue of a patient (e.g., a target volume 14) may be irradiated with the particle beam 12. The particle therapy system 10 may also be used for irradiating an inanimate body such as, for example, a water phantom or some other phantom. Irradiating the water phantom may be done, for example, for the sake of checking and verifying irradiation parameters before and/or after an irradiation of a patient is done. Other bodies (e.g., experimental constructions such as cell cultures or bacterial cultures) may be irradiated with the particle beam 12 for research purposes. In all cases, this may involve bodies that are moving. The target volume 14 may be located invisibly inside a target object 18 and may move quasi-cyclically inside the target object 18.

The particle therapy system 10 may include an accelerator unit 16 such as, for example, a synchrotron, a cyclotron, or another accelerator, which furnishes a particle beam 12 with the requisite energy for the irradiation. Protons, pions, helium ions, carbon ions, or ions of other elements may be used as the particles. In one embodiment, the particle beam 12 has a beam diameter of 3-10 mm width at half-height.

In the target volume 14 to be irradiated, isoenergy layers and target points that are scanned successively in the irradiation by a raster scanning process are indicated schematically. A raster scanning process may be employed. In the raster scanning process, the particle beam 12 is guided from target point to target point without necessarily shutting off at a transition from one target point to the next. Other scanning processes may be used as well. Embodiments with completely different irradiation methods such as irradiation with therapeutic X-rays, electron beams, or particle beams that are employed with a passive beam application (e.g., flaring and shaping of the particle beam 12) may be employed.

The particle beam 12 shown in FIG. 1 is varied in a lateral deflection with the aid of scanning magnets 30. In other words, the particle beam 12 is deflected in a direction (e.g., the X and Y directions) perpendicular to the direction, in which the beam extends.

For detecting the motion of the target volume 14, a detection device 32 is also provided. An external substitute motion signal may be recorded with the detection device 32. For example, the detection device 32 may be a lap belt, from the elongation of which a signal course that allows a conclusion to be drawn about a course of a respiratory cycle of the patient and thus indirectly about a position of a tumor that moves along with respiration may be recorded.

For detecting the motion of the target volume 24, a fluoroscopy device including a radiation source 20 and a beam detector 22 is also provided. The fluoroscopy device is capable of making continuous or individual X-ray images of the target volume 14.

The irradiation system 10 also includes a flow controller 36 and detectors 34 for monitoring beam parameters. The flow controller 36 (e.g., a control system of the irradiation system 10) controls the individual components of the irradiation system 10 (e.g., the accelerator 16 and the scanning magnets 30) and collects measurement data such as, for example, data from the detectors 34 for monitoring the beam parameters. In one embodiment, the control is effected based on an irradiation plan 40. The irradiation plan 40 is ascertained and furnished with the aid of an irradiation planning device 38. The flow controller 36 is configured, for example, for switching the particle beam 12 on and off.

An evaluation device 46 is also integrated with the flow controller 36. With the evaluation device 46, the substitute motion signal recorded by the detection device 32 may be evaluated. The evaluation device 46, with the aid of the substitute motion signal, may ascertain a gating slot, for example.

An image evaluation device 42 is also integrated with the flow controller 36. With the image evaluation device 42, the image data of the fluoroscopy device may be evaluated and compared with other image data. A control device 44 is also integrated with the flow controller 36. With the control device, the fluoroscopy device, with which the recording of image data is performed, is controlled.

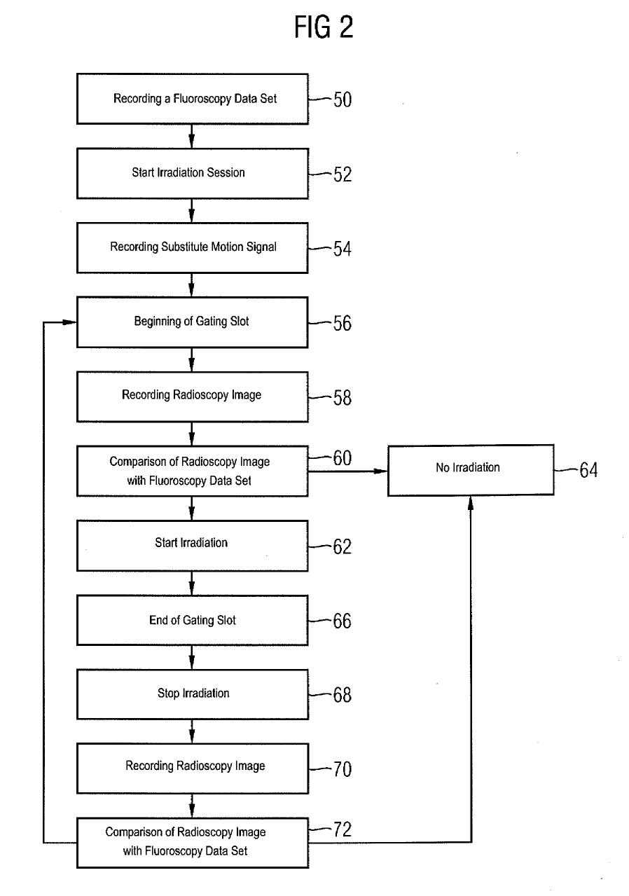

In the particle therapy system 10 shown in FIG. 1, embodiments may be implemented. Possible embodiments will be described in further detail in conjunction with FIG. 2.

FIG. 2, in a schematic flow chart, shows how the external substitute motion signal may be used to control an imaging device (e.g., the fluoroscopy device).

This embodiment and embodiments that follow are demonstrated in further detail in terms of an example relating to a gating process. Other embodiments of the method may, however, relate analogously to a tracking process (tracking the beam of the motion of the target volume) or to a rescanning process (repeated applications of the irradiation dose in immediate succession, to reduce any incorrect irradiations of the target volume by averaging).

In a first act, immediately before the beginning of an irradiation session, a fluoroscopy data set is prepared by the fluoroscopy device as a reference data set. The fluoroscopy device completely images one total motion cycle of the target volume (act 50). A comparison may be made with a planning data set in order to calibrate the motion cycle of the target volume in a form immediately prior to the beginning of the irradiation with a motion cycle used in the planning. Parallel to this, the substitute motion signal may be recorded. A correlation between the substitute motion signal and the motion cycle may be ascertained, or a correlation already ascertained in the planning phase may be modified and adapted to the actual situation.

The irradiation session is started (act 52). During the irradiation session, the substitute motion signal is recorded (act 54). From the substitute motion signal, the beginning of a gating slot is ascertained (act 56) (e.g., a time slot, during which an irradiation of the target volume may be accomplished). The location of the gating slot in the motion cycle of the target volume may be already defined during the planning and may optionally be checked and/or adapted to the actual situation in act 50.

The beginning of the gating slot does not yet trigger the switching on of the treatment beam. At the beginning of the gating slot, a radioscopy image is recorded with the fluoroscopy device; the recorded radioscopy image represents a location of the target volume at the beginning of the gating slot (act 58).

Immediately after being made, the recorded radioscopy image is compared with the fluoroscopy data set, so that it may be determined whether the target volume is located at the desired position in the motion cycle (act 60).

If the result of the comparison is positive (e.g., if the target volume is located approximately at the point where the target volume should be as assumed in the planning), then the treatment beam may be switched on (act 62). Thus, in this case, an irradiation of the target volume may be performed with the desired accuracy.

If in the comparison it is found that the target volume has deviated too far from the ideal position, the gating slot cannot be ascertained correctly from the substitute motion signal. The irradiation may be interrupted before the target volume is irradiated incorrectly (act 64). In one embodiment, one or more threshold values for allowable deviations are defined, since it may not expected that the image data to be compared will match exactly.

As soon as the end of the gating slot is reached (act 66), the irradiation is interrupted (step 68). Alternatively, the irradiation is interrupted as soon as the entire target volume has been irradiated.

In one embodiment, at the end of the gating slot, a further radioscopy is prepared (act 70) so that the location of the target volume in comparison to the fluoroscopy data set may also be monitored at the end of the gating slot (act 72). If this comparison has a positive outcome, the irradiation is continued (e.g., the next gating slot is ascertained, and the algorithm described is repeated until such time as the irradiation has either ended or been interrupted). If the outcome of the comparison is negative, the irradiation session is interrupted (act 64).

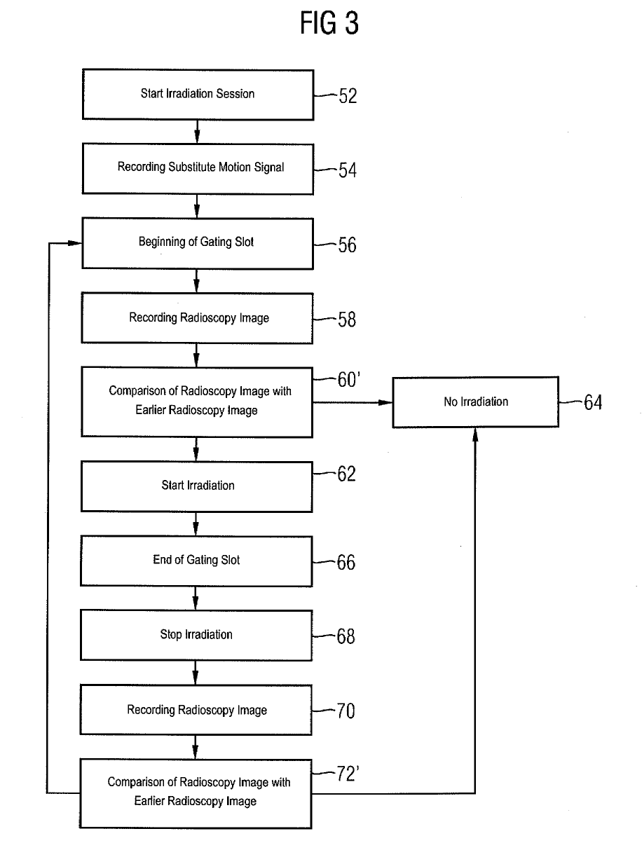

FIG. 3 shows a schematic flow chart of a slightly modified method.

In the modified method, the radioscopy image that had been recorded at the beginning of a gating slot is compared not with a reference image but with the previous radioscopy imagerecorded during the previous gating slot (act 60′). The radioscopy image of the first gating slot may be compared with a planning data set or with a reference fluoroscopy data set, as in FIG. 2. Also, act 72 is replaced with step 72′, so that the radioscopy image that is recorded at the end of the gating slot is compared with a corresponding earlier radioscopy image.

By the comparison of the radioscopy images from one gating slot to the next, a gradual shift or drift in the location of the target volume in comparison to the substitute motion signal may be ascertained. For example, if a lung tumor is to be irradiated, the motion of the tumor may have a drift compared to the substitute motion signal, caused, for example, by gradual relaxation of musculature of the patient.

This drift in the tumor motion may be detected even without the fluoroscopy device being constantly active. Parallel to this, a check may be made as to whether the gradual variation in the tumor motion is still covered by the original planning (e.g., with regard to margins of safety, an overlap with organs that are to be protected from radiation, and so forth).

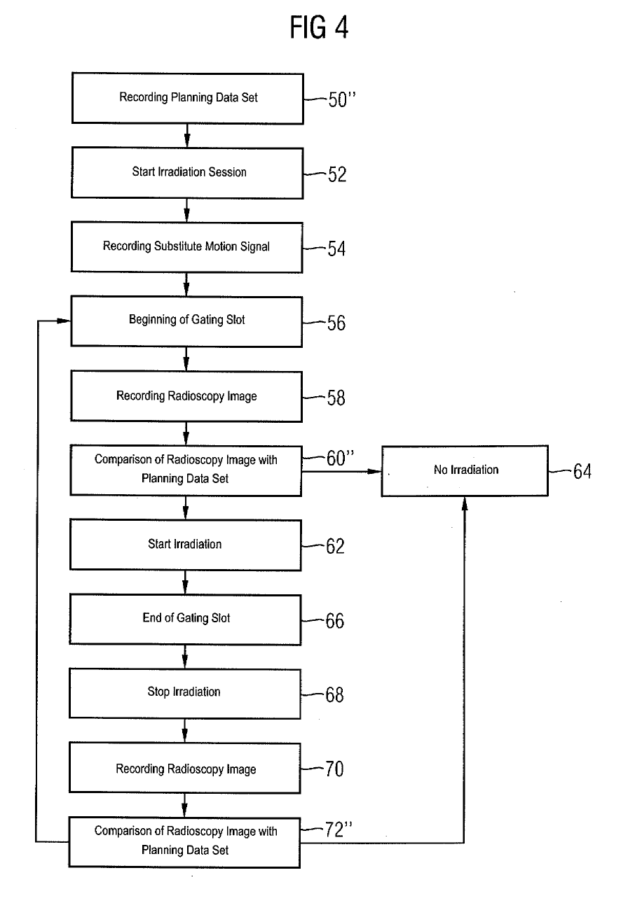

FIG. 4 shows a method that is modified compared to FIG. 2. Before the beginning of the irradiation, instead of the reference image made by the fluoroscopy device from the planning data set (e.g., a three- or four-dimensional CT data set), one or more digitally reconstructed radiographs (DRRs) are generated (act 50″) (e.g., from a virtual direction that corresponds to the imaging direction of the fluoroscopy device). The radioscopy images that are recorded by the fluoroscopy device at the beginning of the gating slot are compared with the corresponding DRR or DRRs (act 60″). The same is true for the radioscopy image that is recorded at the end of the gating slot (act 72″). Alternatively or in addition, a calibration of radioscopy image data with other plane images (e.g., slices through an associated magnetic resonance dataset) may be performed.

The embodiments described may also be combined with one another. For example, the various embodiments may be used in alternation from one gating slot to another, in parallel with the aid of two evaluation computers, or serially per gating slot.

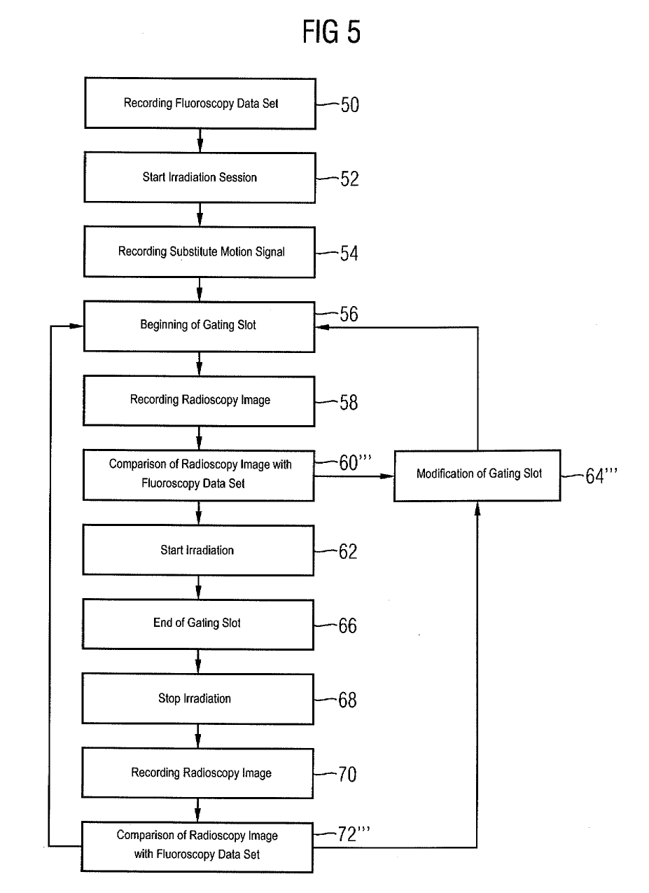

FIG. 5 shows a further modification. The comparison, described in the exemplary embodiments, of a recorded radioscopy image of a further view may also be designed such that the recorded radioscopy image is compared with a plurality of views recorded at different times (e.g., with all the radioscopy images recorded previously) or with a plurality of DRRs (act 60′″ and act 72′″). In this way, whether the gating slot is shifting may be detected.

If a drift is found, the gating slot specified in the irradiation planning may be adapted actively (act 64′). This may be done, for example, by adapting and shifting the triggering times of the external substitute motion signal. This offers the advantage that the irradiation need not be interrupted or stopped. The radioscopy images recorded at the end of the gating slot offer the capability of adapting the width of the gating slot (e.g., the length of the particular irradiation slot).

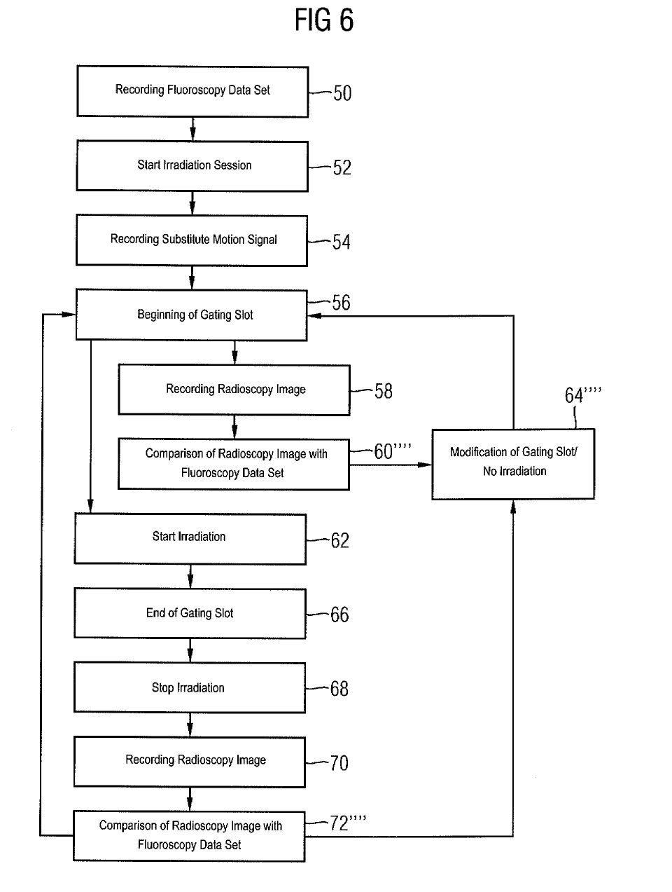

In another embodiment (FIG. 6), switching the beam on and off (act 62) is triggered by the substitute motion signal, independently of the particular comparison at the time of the radioscopy image (act 60″″). The radioscopy images are, however, used for checking the validity (e.g., whether the existing gating slot is still valid in comparison with the assumptions made in the planning phase). The next beam activations to be done during the next gating slots may either be suppressed, or the gating slot may be adapted (act 64″″). In case the location of the target volume is correct, however, the next gating slot is executed without modifying the gating slot or interrupting the irradiation. The same is true for the radioscopy images that are recorded at the end of the gating slot (act 72″″).

In a further embodiment, if deviations are found, the fluoroscopy device may be controlled such that fluoroscopy views are made continuously, or at least a plurality of fluoroscopy views are made, so that the gating slot for the external motion detection may be re-determined based on the internal motion data of the target volume.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A device for controlling an irradiation system for irradiating a moving target volume, the device including:
an evaluation device operable to evaluate a substitute motion signal, the substitute motion signal being a signal varying as a function of motion of the moving target volume;
an imaging device operable to record image data of the moving target volume, the imaging device comprising a control device, the control device being configured to control the imaging device and being configured for activating and deactivating the imaging device as a function of the evaluation of the substitute motion signal;
an image evaluation device operable to evaluate the image data recorded by the imaging device; and
an irradiation device comprising an irradiation control device, the irradiation control device being configured for controlling an irradiation procedure as a function of the evaluation of the image data, the evaluation of the substitute motion signal, or the evaluation of the image data and the evaluation of he substitute motion signal.

2. The device as defined by claim 1, further including a detection device operable to record the substitute motion signal at a sampling rate of at least 10 Hz.

3. The device as defined by claim 1, wherein the image evaluation device is operable to compare the recorded image data with further image data recorded at an earlier time.

4. The device as defined by claim 3, wherein the image evaluation device is operable to ascertain a difference between the recorded image data and the further image data, and
wherein the irradiation control device is configured to activate the irradiation device only when the ascertained difference is below a threshold value.

5. The device as defined by claim 3, wherein the further image data comprises planning image data.

6. The device as defined by claim 3, wherein the further image data comprises image data recorded using the imaging device.

7. The device as defined by claim 1, wherein the irradiation control device is configured for adapting a time slot, during which the irradiation device is activatable, as a function of the evaluation of the image data.

8. A method for controlling an irradiation system for irradiation of a moving target volume, the method comprising:
evaluating a substitute motion signal, the substitute motion signal being a signal varying as a function of a motion of the moving target volume;
recording image data of the moving target volume as a function of the evaluation of the substitute motion signal;
evaluating the recorded image data;
controlling an irradiation procedure as a function of the evaluation of the recorded image data, the evaluation of the substitute motion signal, or the evaluation of the recorded image data and the evaluation of the substitute motion signal.

9. The method as defined by claim 8, further comprising recording, evaluating, or recording and evaluating the substitute motion signal at a sampling rate of at least 10 Hz.

10. The method as defined by claim 8, wherein evaluating the recorded image data comprises comparing the recorded image data with further image data recorded at an earlier time.

11. The method as defined by claim 10, wherein comparing the recorded image data with further image data comprises ascertaining a difference, and
wherein the method further comprises activating the irradiation system only when the ascertained difference is within a tolerance range.

12. The method as defined by claim 8, further comprising modifying a time slot, during which the irradiation system is activated, as a function of the evaluation of the recorded image data.

13. The method as defined by claim 9, further comprising modifying a time slot, during which the irradiation system is activated, as a function of the evaluation of the recorded image data.

14. The method as defined by claim 11, further comprising modifying a time slot, during which the irradiation system is activated, as a function of the evaluation of the recorded image data.

15. The method as defined by claim 10, wherein the further image data comprises image data from a planning data set.

16. The device of claim 1, wherein the irradiation control device is configured for controlling the irradiation procedure as a function of the evaluation of the image data, the evaluation of the substitute motion signal, or the evaluation of the image data and the evaluation of the substitute motion signal for activating and deactivating the device.

17. The device as defined by claim 2, wherein the image evaluation device is operable to compare the recorded image data with further image data recorded at an earlier time.

18. The device as defined by claim 4, wherein the further image data comprises planning image data.

19. The device as defined by claim 5, wherein the further image data comprises image data recorded using the imaging device.

20. The device as defined by claim 2, wherein the irradiation control device is configured for adapting a time slot, during which the irradiation device is activatable, as a function of the evaluation of the image data.
